(19) United States
(12) Patent Application Publication
(10) Pub. No.: US 2026/0356653 A1
(43) Pub. Date: Nov. 12, 2026

(54) WATER CARBONATOR HAVING A WATER FILTER

(71) Applicant: ACLARIS GmbH, Lindau, Zweigniederlassung Rebstein, Rebstein (CH)

(72) Inventor: Roland SCHOLZ, Budapest (HU)

(73) Assignee: ACLARIS GmbH, Lindau, Zweigniederlassung Rebstein, Rebstein (CH)

(21) Appl. No.: 19/712,582

(22) Filed: Jun. 18, 2026

Related U.S. Application Data
(63) Continuation of application No. PCT/EP2025/056801, filed on Mar. 12, 2025.

(30) Foreign Application Priority Data
Apr. 3, 2024 (DE) 10 2024 109 364.1
Apr. 10, 2024 (DE) 10 2024 110 041.9

(51) Int. Cl. B67D 1/00; A23L 2/54; B67D 1/04; B67D 1/10

(52) U.S. Cl. CPC B67D 1/0072; A23L 2/54; B67D 1/0058; B67D 1/006; B67D 1/0406; B67D 1/105; B67D 2210/0001

(57) ABSTRACT

A sparkling water device and method are provided that comprises an integrated water filter and/or mineralization stage, which can enable quick preparation of high-quality sparkling water despite varying water qualities of the water to be treated. The water is forced through the filter and/or the mineralization stage by the CO₂ gas pressure of the gas cylinder.

This nonprovisional application is a continuation of International Application No. PCT/EP2025/056801, which was filed on Mar. 12, 2025, and which claims priority to German Patent Application No. 10 2024 109 364.1, which was filed in Germany on Apr. 3, 2024, and German Patent Application No. 10 2024 110 041.9, which was filed in Germany on Apr. 10, 2024, and which are both herein incorporated by reference.

### BACKGROUND OF THE INVENTION

### Field of the Invention

The invention relates to a sparkling water device.

### Description of the Background Art

State-of-the-art sparkling water devices or soda makers, carbonation devices or soda makers have been in use for many years to enrich tap water with carbon dioxide or CO₂ as an alternative to mineral water or carbonated table water in bottled containers, so-called bottled water. A method for this is described in DE 10 2008 012 486 A1, for example.

By using sparkling water devices, carbonated water can be produced directly at the point of consumption, thus eliminating the need to transport disposable or reusable containers of carbonated mineral or table water in plastic or glass bottles. By dispensing with so-called bottled water, the CO₂ food print from the transport and production of the containers can be reduced and energy and material for production can be saved.

As an alternative to the use of bottled water in disposable plastic bottles, sparkling water devices also counteract the plastic waste problem, buzzword “plastic-contaminated oceans”, and the accumulation of plastic in the food chain (so-called microplastic accumulation).

In particular soda makers by the company SodaStream (Israel) (sparkling water devices with the trade names “Soda-Club” and “SodaStream”) have been used for many years in private households for the simple production of sparkling water from tap water. These soda makers are characterized by a simple design, as they do not require any electricity. The devices are extremely compact, require only a small footprint and can be operated without being connected to the drinking water supply. By opening a valve manually, by hand, a quantity of water pre-filled into a bottle-shaped, pressure-resistant container is enriched with carbon dioxide from a pressure cylinder pre-filled with CO₂. After decoupling the bottle-shaped container from the sparkling water device, it can be used directly as a transport container for the sparkling water.

The disadvantage of these devices as compared to most professional soda water machines, dispensing systems and household sparkling water makers with power connection is a lack of a cooling unit to lower the water temperature, a lack of a feed pump and a quantity of water predetermined by the discontinuous displacement of a fixed amount of water.

Another disadvantage of these simple soda makers is their dependence on the quality of tap water available at the place of use, which, depending on the origin of the water (surface water, groundwater, seawater, brackish water, etc. . . . ), the treatment technology used (seawater desalination, UV disinfection, chlorination, etc. . . . ) and its general suitability as drinking water or its mineral and taste suitability for use as sparkling water, may be limited or not suitable at all.

Depending on the region, the use of these simple sparkling water devices is thus limited due to the different types of tap water quality available, or upstream treatment of the tap water becomes necessary.

For this purpose, a sparkling water device is known from US 2023/0285912 A1 that allows for such upstream treatment. The device has its own water reservoir. If necessary, an electrically operated pump is switched on, which pumps the water from the reservoir into a water bottle. On the way to the water bottle, the water is pumped through a filter by means of the electric pump. A controller is provided to control the flow of water.

In addition, piped water filter systems installed upstream of the tap or at the tap have become established, as have so-called water filter pitchers, e.g., from Brita in Taunusstein, Germany, with which a given amount of water can be filtered gravimetrically using a two-chamber system (upper chamber for impure water, lower chamber for pure water).

However, these water filtration systems require additional investment in installation, need additional installation or storage space in the kitchen, and reduce the simplicity and speed of preparing sparkling water with the sparkling water device, as—in particular when a water filter pitcher is used—it is necessary to wait for the required amount of water to be filtered.

In addition, WO 2023/138 994 A1 (which corresponds to US 2025/0065280) describes a household appliance for dispensing drinking water having a continuous-flow enrichment unit. Furthermore, WO 2022/234 895 A1 (which corresponds to US 2024/0181374) describes water purification systems operated by air pressure.

### SUMMARY OF THE INVENTION

It is therefore an object of the present invention to provide a simplified sparkling water device which, despite varying water quality of the water to be treated allows for rapid preparation of high-quality sparkling water with defined properties.

In an example, the invention proposes integrating a water treatment step into a sparkling water device to ensure water conditioning through filtration or by adjusting the mineral content for the production of sparkling water in a quality that meets consumer-requirements.

The invention also provides a combination of a water filter system and a simple sparkling water device without a feed pump, without an electrical connection and without hydraulic and/or pneumatic connection to a tap water supply, and therefore also avoids the disadvantages of a separate water filter and sparkling water device.

Accordingly, the invention is characterized in that the flow through the water treatment stage in the sparkling water device can be achieved by using the pressure applied from a pressure cylinder filled with CO₂ gas used in the sparkling water device.

By using the CO₂ gas pressure, the water can be forced through a filter and/or through a mineralization stage to enrich the water with minerals and be treated, which enables efficient water treatment without the need for the additional integration of an electrically driven feed pump, without connecting the device to a tap water supply and without the disadvantages of the alternative combinations with externally operated water treatment systems described above.

However, filtration or mineralization between the beginning and end of the CO₂ carbonation of the water is also possible in order to obtain optimal sparkling water quality.

Further, the water can be driven through a filter by a hydraulic and/or CO₂ gas-driven pneumatic pump.

The water could be driven by CO₂ gas and forced through the water filter and/or the mineralization stage, and a special gas pressure accumulator could be charged with CO₂ gas, which releases its pressure again in the process of carbonating the water.

The filter can also serve as a CO₂ gas distributor (gas distribution frit), through which the gas is introduced into the water in small bubbles via a porous structured filter body. When the sparkling water is withdrawn, the flow of sparkling water through the filter takes place by reversing the pressure ratios in the opposite direction.

The filter and/or mineralization stage can be integrated into a carbonator (pressure vessel in which the water is enriched with CO₂), which is integrated into the sparkling water device and from which the filtered sparkling water can be tapped from the device in different portions.

The filter used in the sparkling water device can be used to reduce chlorine from tap water and/or to reduce heavy metals and/or organic impurities, such as chlorination by-products, pesticides, medical residues, hormones, particles and/or to reduce water hardness and/or microorganisms and/or fine plastics.

The filter can include a compressed filter granulate and/or granules of ion exchange resin, which are solidified in a sinter-like manner and shaped at low temperatures using binding agents, and/or activated carbon granulate (in the professional jargon of the filter industry, also referred to as carbon filter blocks) or other combined filter materials or mineralization materials or mineralization granules.

The filter can have a stable three-dimensional structure with a fine porous structure, for example in the form of a filter block, through which the CO₂ gas can be introduced into the water in fine bubbles, in particular for better absorption of the CO₂ gas in the water, and when the flow is reversed, the water enriched with CO₂ gas can be filtered through the filter in the opposite direction to that used when introducing the CO₂ gas.

A mineralization stage specially designed for remineralization, for example in the form of a mineralization cartridge, can also be integrated into the sparkling water device in order to enrich water that has a low mineral content, for example if the tap water comes from seawater desalination or if the water used has previously been desalinated by a reverse osmosis system, to a desired mineral content.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a sparkling water device with carbonator and downstream filtration and/or mineralization and water storage tank from which the sparkling water can be taken in portions;

FIG. 2 is a schematic representation of a sparkling water device, similar to that shown in FIG. 1, but with a direct withdrawal option from the carbonator through the filter and/or the mineralization stage;

FIG. 3 is a schematic representation of a sparkling water device with pre- and final carbonation, which are interposed by filtration and/or mineralization;

FIG. 4 is a schematic representation of a sparkling water device with a carbonator, wherein filtration and/or mineralization and/or gas-powered water feed are upstream of carbonation and portioned withdrawal from the carbonator is carried out;

FIG. 5 is a schematic representation of a sparkling water device similar to

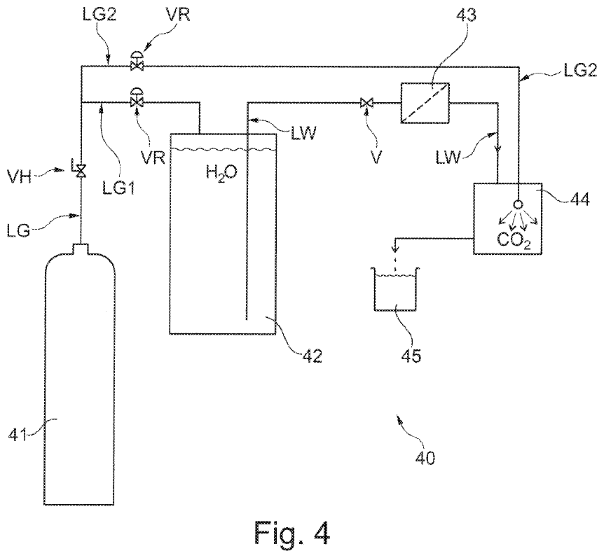

FIG. 4, but with filtration and/or mineralization stage in the storage tank;

FIG. 6 is a schematic representation of a sparkling water device with pre- and final carbonation as well as gas-driven pump, which is driven by CO₂ gas from the gas cylinder and forces pre-carbonated water through the filtration and/or mineralization stage into the final carbonator, from which a portioned removal takes place;

FIG. 7 is a schematic representation of a sparkling water device with a water filter and/or mineralization stage in the carbonator, which in the process of carbonation serve as CO₂ gas distribution frits or filter frits and are also designed to allow for the sparkling water to be filtered through the filter and/or mineralization stage when the sparkling water is withdrawn and the pressure conditions are reversed; and

FIG. 8 is a schematic representation of a sparkling water device with a gas-driven pump and pressure accumulator, which is charged with CO₂ gas during water filtration and/or mineralization and releases its pressure again in the process of carbonation of the water.

### DETAILED DESCRIPTION

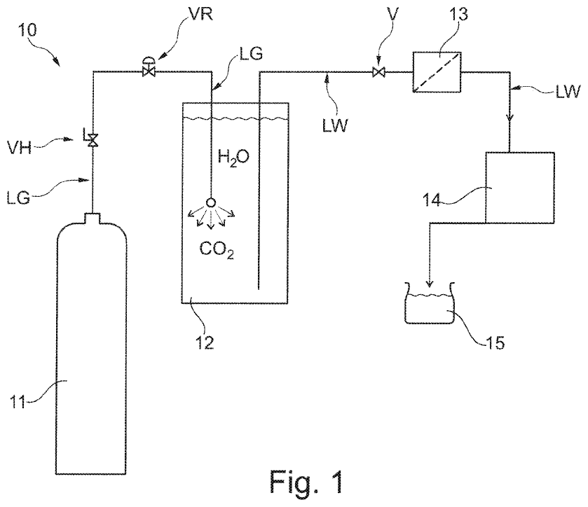

FIG. 1 shows a schematic representation of a sparkling water device 10 in which a CO₂ gas cartridge 11 can introduce CO₂ gas into a water reservoir 12 via a line LG. The line LG can be opened, partially opened or closed via a tap VH for general shut-off of the gas cartridge 11 and via a control valve VR for pressure adjustment and regulation of the gas. The water reservoir 12 is used to store water for the production of sparkling water. By introducing CO₂ gas into the water-filled reservoir 12, the water can be carbonated, i.e., the reservoir 12 also serves as a carbonator. Due to the pressure that arises during carbonation by introducing gas into the reservoir or the carbonator 12, the carbonated water is forced into the line LW and passes through a filter 13. It is also possible that instead of a filter 13 or in addition to the filter 13, a mineralization stage is connected to the line LW for the mineralization of the water. The flow through the line LW can also be adjusted via a valve V. In this example, the carbonated sparkling water is fed into a pressure vessel 14 and stored. If necessary, the water can be poured from the pressure vessel 14 into a water glass 15, e.g., through a sealable opening, through a tap or the like.

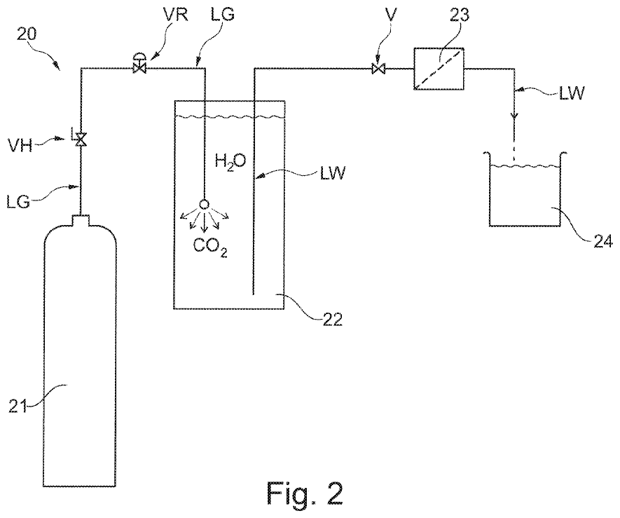

A variant very similar to FIG. 1 is shown in FIG. 2, namely a sparkling water device 20 in which CO₂ is also pumped from a gas cartridge 21 via a gas line LG into a reservoir 22, which also serves as a carbonator. The pressure brings the carbonated water to a filter or mineralization stage 23. From there, the sparkling water can be fed via the line LW directly into an open vessel 24, e.g., a pitcher or a drinking glass.

Advantageously, water reservoirs 12 and 22 have a triple functionality: the basic function as water storage; the function as a carbonator to produce sparkling water; and the function of water transport, because the introduction of CO₂ gas creates pressure and forces the water through the water line LW and thus also through downstream filters 13, 23.

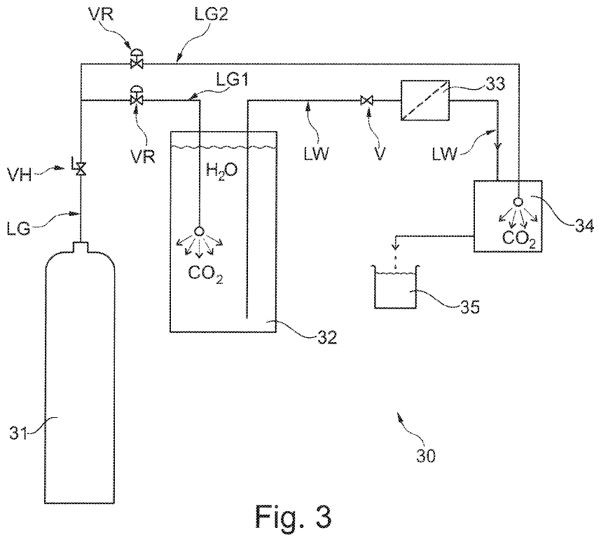

In the example according to FIG. 3, on the other hand, it is possible to work with lower pressure because the pressure is distributed over at least two lines with which different functions are fulfilled. This sparkling water device 30 is also initially equipped with a gas cartridge 31 and a water reservoir 32. However, the water reservoir 32 is used here for pre-carbonation and for the further transport of the water using the pressure during carbonation. In this context, the term “pre-carbonation” can be used because, at the end, a tank 34 is provided for final carbonation. The path of the water up to this point, however, is basically analogous to the devices 10, 20 according to FIGS. 1, 2. This means that the water is forced from the pre-carbonator 32, through the line LW, through the valve V, through the filter 33 (and/or a mineralization stage) into the pressure vessel 34.

However, a further difference to the examples according to FIGS. 1, 2 is that the original gas line LG, which is directly connected to the gas cartridge 31 and can be shut off via the tap VH, is divided into two gas lines LG1 and LG2: The line LG 1 flows into the water reservoir 32, wherein the gas flow can be adjusted by a control valve VR. This gas flow through the line LG1 is used on the one hand for pre-carbonation in the reservoir 32 and on the other hand for the transport of the water through the line LW. The line LG2, which branches off from the line LG together with the line LG1 and is connected in parallel to the line LG1, will transport the gas directly into the pressure vessel 34, where it can be used for final carbonation. The flow through the line LG2 can also be adjusted by a separate control valve VR.

The sparkling water can be removed from the pressure vessel 34 via a tap or a sealable opening for pouring, here into a water glass 35.

The sparkling water device 40 according to FIG. 4 is in turn similar to the sparkling water device 30 from FIG. 3, but the water reservoir 42 is only used to store water and transport it further using gas pressure. The line LG, which transports the gas from the gas cartridge 41, in turn branches into two lines LG1 and LG2. As in FIG. 3, the line LG2 also ends in the pressure vessel 44 where carbonation takes place. The line LG1 also ends in the reservoir 42 accordingly, but it is usually arranged at the lid and not in the water in such a way that it does not initiate a (pre-)carbonation process, but only applies pressure on the water, so that it is forced into the line LW. The water passes through the water line LW, through the filter 43 (or the mineralization stage) into the pressure vessel 44, where carbonation then takes place through the introduction of CO₂ gas. The sparkling water can be withdrawn with a drinking glass, for example.

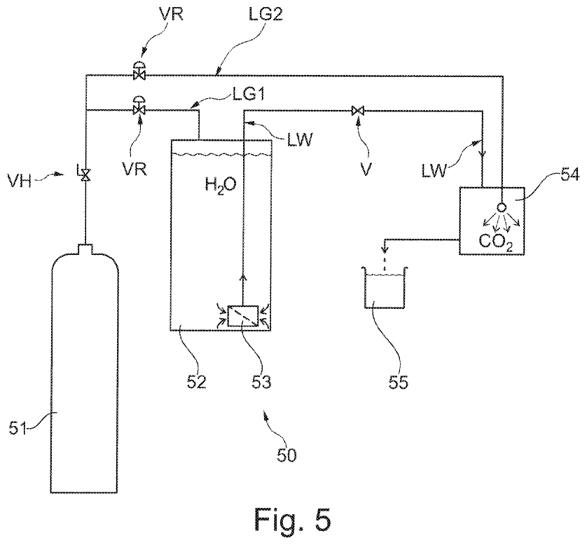

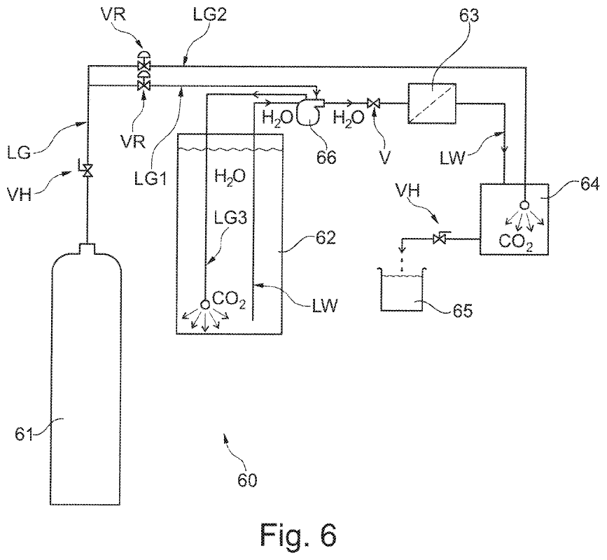

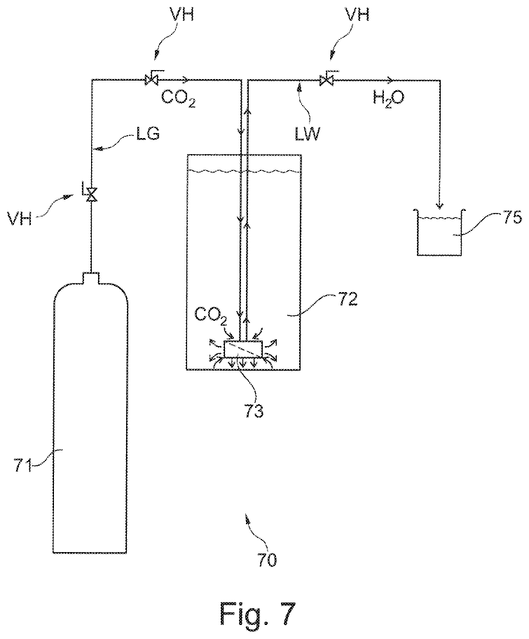

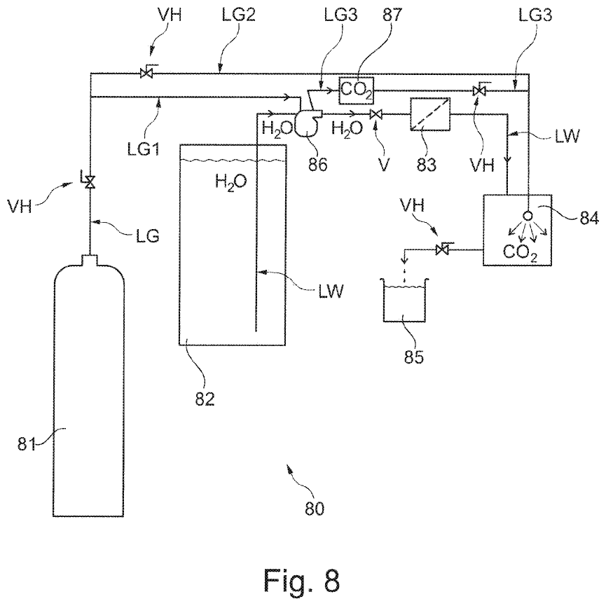

FIG. 5 shows a particularly compact example of the sparkling water device 50 with a gas cartridge 51. The line LG from the gas cartridge branches off again into two lines LG1 and LG2, wherein the line LG2 also flows into a pressure vessel 54 as a carbonator, whereas the line LG1 ends in a reservoir 52 for water storage. However, the reservoir 52 does not have the function of a carbonator. The line LG1 opens into the reservoir 52 in such a way that the gas introduced only applies pressure on the stored water and then forces it into the water line LW.

However, in FIG. 5, a filter 53 is arranged in the reservoir 52. Instead of a filter, a mineralization stage may also be used to mineralize the water or a device that includes the filter and the mineralization stage. Here, filter and/or mineralization stage is/are arranged in the reservoir tank 52 and is/are located in the water. The filter and the mineralization stage is/are designed to have an inlet and outlet that flow directly into the water line LW.

If the water is pressurized by the introduction of CO₂ gas, the incompressible water can yield to the pressure by flowing into the filter or mineralization stage, passing through these and entering the water line LW via the outlet. From there, the water flows further into the pressure vessel 54 for carbonation, into which the line LG2 also flows, but in such a way that the end of the line LG2 for carbonation is located in the water.

Furthermore, control valves VR may be located on the lines LG1 and LG2 in order to adjust the gas flow. A valve V can also be arranged on the water line LW. The CO₂ cartridge can be shut off with a tap VH, for example.

Finally, carbonated sparkling water can be poured directly into a drinking glass 55 from the tank 54.

FIG. 5 thus represents an example that shows, for example, a water tank as a reservoir 52, which can be equipped with a filter cartridge or a filter candle. The filter cartridge or candle is located in the tank and is permanently in the water. It has an inlet and an outlet and can be flowed through. The arrangement of the filter or the mineralization stage would therefore be similar to that in a fully automatic coffee machine, but in fully automatic coffee machines the water is usually sucked out of the tank by an electric pump, which is not necessary here.

In FIG. 6, a pump 66 is shown. However, it is not an electrically operated pump, but a gas-powered pump. Again, the line LG splits from the gas cartridge 61 into two parallel lines LG1 and LG2, wherein the line LG2 opens into a pressure vessel 64 for carbonation, or actually for final carbonation. However, the line LG1 now leads to the pump 66 and drives it with gas.

The gas that drives the pump 66 can continue to be used: it flows out via a line LG3 and is fed into the reservoir 62 to carry out pre-carbonation there and at the same time to force the water, which is incompressible and cannot escape, through the water line LW by increasing the pressure. Above all, however, the water is sucked from the reservoir 52 into the water line LW by the pump 66. The simultaneous action of the pump suction and the pressure of the CO₂ gas introduced into the reservoir 62 achieves a particularly effective and/or complete transport of the volume of water from the reservoir 62.

The pump 66 pumps the water further through the filter 63 and/or mineralization stage into the tank 64 into which the line LG2 opens for final carbonation.

It is possible to withdraw the sparkling water via another tap VH into a drinking glass 65.

A particularly preferred further development of the invention is shown in FIG. 7, which above all represents a very compact structure and shows a simple line routing that also requires few valves. The line LG (which can be shut off by a tap) leads directly into the water reservoir 72, which also serves as a carbonator. The gas line is directly connected to a so-called gas distribution frit or filter frit 73, which is formed of a porous structured filter material and allows for a fine distribution of the gas into the water. Once carbonation is complete, the sparkling water can be taken directly from the water reservoir 72. In this case, the sparkling water is forced by the CO₂ pressure in the water reservoir 72 in the opposite direction through the filter 73, enters the water line LW and can be portioned via a tap VH into a drinking glass 75 or into other containers, such as a storage pitcher or sealable water bottle.

A mineralization function for sparkling water can also be integrated into the filter, or a mineralization stage can be used instead of the filter.

In this example, the filter and/or mineralization stage 73 have a dual function. On the one hand, they serve as a gas distribution frit during carbonation of the water in the water reservoir 72 and, after carbonation has been completed and when the sparkling water is extracted, as a filter or mineralization stage for the sparkling water.

As a filter or mineralization stage, the frit 73 can comprise a granular material that forms or has a porous structure and can be used to filter the sparkling water. The gas connection or the gas line LG and the water line LW can be connected directly to the gas distribution frit or filter frit 73.

FIG. 8 in turn shows a similar example to FIG. 6, but the reservoir 82 is not used for pre-carbonation. The line LG leading from the gas cartridge 81 is divided into the two lines LG1 and LG2, wherein the line LG1 is directly connected to a pump 86 and drives the pump 86, so that pump 86 sucks water from the reservoir 82 through the water line LW. The pump 86 pumps the water further through a filter 83 and/or a mineralization stage into a tank 84, which serves as a carbonator.

A line LG3 leads out of the pump 86, with which the gas for driving the pump 86 can be passed to a pressure accumulator 87 and stored. The CO₂ gas stored in the pressure accumulator 87 can pressurize the tank 84 via the line LG3 and be used for pre-carbonation. The final carbonation in the tank 84 is also carried out via the gas line LG2 (with a shut-off valve VH), through which the tank 84 or the carbonator can be directly pressurized with CO₂ gas.

the carbonator 84 can be emptied via a tap VH (e.g., into a drinking glass 85).

The pressure accumulator 87 is a gas storage tank for the temporary storage of the gas. The pressure accumulator 87 can also be designed as an expansion vessel which expands when filled with gas via an elastic diaphragm and contracts again when emptied (e.g., by opening a valve in its outlet) by contracting the diaphragm.

Overall, the valves are only shown as examples in all FIGS. 1-8. Other valves may be used if necessary. It is also possible that individual valves are not necessary and can be omitted.

What all examples and further developments of the invention have in common is that carbonated sparkling water can be produced without a long delay, but which is filtered and/or mineralized and of high quality with defined properties. However, according to the invention, the sparkling water device is simplified and environmentally friendly because the pumping process for transporting the water is carried out by the gas pressure, which is already used for carbonation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sparkling water device comprising:
an integrated water filter and/or mineralization stage,
wherein the sparkling water device is designed so that the water to be treated is forced through the filter and/or the mineralization stage via a CO₂ gas pressure of a gas cylinder,
wherein the sparkling water device is designed to force the water through the filter and/or mineralization stage prior to CO₂ enrichment or carbonation, or the filter and/or the mineralization stage for filtration and/or mineralization of the water is/are disposed between a beginning and end of the CO₂ gas enrichment or carbonation of the water.

2. The sparkling water device according to claim 1, further comprising a hydraulic and/or a pneumatic pump, which are adapted to be driven by the CO₂ gas pressure in order to force the water through the filter via the hydraulic and/or pneumatic pump.

3. The sparkling water device according to claim 1, wherein the filter and/or the mineralization stage is designed as a CO₂ gas distributor or frit in order to introduce the CO₂ gas into the water through this/these.

4. The sparkling water device according to claim 1, wherein the filter and/or mineralization stage is designed as a CO₂ gas distributor or frit (73) and is further designed to ensure that in a reversal of the pressure ratios, the sparkling water is filtered through the filter and/or mineralization stage.

5. The sparkling water device according to claim 1, wherein the filter is integrated into a carbonator integrated into the sparkling water device from which the filtered water enriched with CO₂ gas is adapted to be tapped from the device in different portions.

6. The sparkling water device according to claim 1, further comprising a water reservoir for the temporary storage of drinking water.

7. The sparkling water device according to claim 6, wherein a gas line for the supply of gas and a water line for the transport of water are attached to the water reservoir in order to force the water through the water line via the gas.

8. The sparkling water device according to claim 6, wherein a gas line is connected to the water reservoir such that the gas is adapted to be discharged into the temporarily stored water, and wherein a water line is provided for the transport of the water, and wherein the water reservoir is so dense that the water is forced through the water line when the gas is introduced.

9. The sparkling water device according to claim 6, wherein the hydraulic and/or pneumatic pump is arranged downstream of the water reservoir.

10. The sparkling water device according to claim 7, wherein the water filter and/or the mineralization stage are:
disposed in the water reservoir; or
disposed behind the water reservoir; or
located behind the hydraulic and/or pneumatic pump, and
wherein the water filter and/or the mineralization stage is formed as a frit.

11. The sparkling water device according to claim 6, further comprising a pressure vessel that is separate from the water reservoir, for the collection of water and for carbonation.

12. The sparkling water device according to claim 6, wherein the gas line is divided into two gas lines, one of which is connected to the water reservoir or to the hydraulic and/or pneumatic pump and the other is connected to the pressure vessel.

13. The sparkling water device according to claim 6, wherein the hydraulic and/or pneumatic pump comprises a gas outlet line via which the gas is directed from the pump into the water reservoir and/or into a pressure accumulator to direct gas into the pressure vessel.

14. A method for the production of sparkling water, the method comprising:
providing a sparkling water device comprising an integrated water filter and/or mineralization stage; and
forcing water through the filter and/or the mineralization stage of the sparkling water device by the CO₂ gas pressure of the gas cylinder, a filtration and/or mineralization of the water taking place between the beginning and end of the CO₂ gas enrichment or carbonation of the water, or forcing the water through the filter and/or the mineralization stage prior to CO₂ enrichment or carbonation.

15. The method according to claim 14, wherein the water is forced through the filter and/or mineralization stage via a hydraulic and/or pneumatic pump driven by the CO₂ pressure.

16. The method according to claim 14, wherein the filter and/or the mineralization stage is used as a CO₂ gas distributor or frit through which the CO₂ gas is introduced into the water.

17. The method according to claim 14, wherein the filter and/or the mineralization stage is used as a CO₂ gas distribution frit or filter frit and, when the pressure ratios are reversed, the sparkling water is filtered through the filter and/or the mineralization stage.

18. The method according to claim 14, wherein the filter is integrated into a carbonator integrated into the sparkling water device, from which the filtered water enriched with CO₂ gas is adapted to be tapped from the device in different portions.
